(19) United States
(12) Patent Application Publication
(10) Pub. No.: US 2015/0185458 A1
(43) Pub. Date: Jul. 2, 2015

(54) GRAYSCALE STIMULATION USING A BINARY SPATIAL LIGHT MODULATOR

(71) Applicant: PHOTONEDGE INC., Pleasanton, CA (US)

(72) Inventors: Ming LI, Toronto (CA); Song PENG, Pleasanton, CA (US)

(21) Appl. No.: 14/586,766

(22) Filed: Dec. 30, 2014

Related U.S. Application Data
(60) Provisional application No. 61/922,375, filed on Dec. 31, 2013.

(51) Int. Cl. G02B 21/06

(52) U.S. Cl. CPC G02B 21/06

(57) ABSTRACT

A method for optically stimulating a specimen is disclosed. The method involves using a spatial light modulator (SLM) to produce an SLM image containing a plurality of regions having different grayscales from each other. Each region is produced by turning on a predetermined percentage of pixels within the region. The predetermined percentage of pixels corresponds to a percentage of grayscale of the region. The method further involves optically projecting the SLM image onto a specimen via an optical system having a sufficient de-magnification such that the specimen treats individual pixels in the SLM image indiscriminately.

### CROSS REFERENCE TO RELATED APPLICATIONS

The present application claims priority to U.S. Provisional Application Ser. No. 61/922,375, filed on Dec. 31, 2013, which is incorporated by reference herein in its entirety.

### FIELD OF THE INVENTION

The present invention relates generally to a field of optics, and more particularly to a method of optically stimulating specimens with different optical intensities.

### BACKGROUND

Applications, such as optogenetics research, often require simultaneously stimulating multiple regions on a specimen, such as neuron(s), with different optical intensities. For example, one may desire to stimulate one area of a specimen with one optical intensity and another area of the specimen with another optical intensity. This is difficult to achieve with a binary spatial light modulator (“SLM”) that typically only outputs two levels of light intensities. In display applications, as a form of varying optical intensity, grayscales are used and realized through pulse-width modulation (“PWM”). In general, optical intensity refers to a level of brightness of light. In PWM, a binary pixel is turned on for a certain duration and then turned off. The duration of the on-time of the binary pixel corresponds to a brightness of the pixel. As such, the longer the on-time, the brighter the pixel.

However, PWM is not suitable for many optical stimulation experiments because PWM introduces unwanted time-dependence in optical intensity. For example, if PWM is carried out at 60 Hz, then a specimen will see the 60 Hz modulation even if one wishes a constant (i.e., not varying with time) stimulation.

### SUMMARY OF THE INVENTION

The present invention provides a way of generating grayscale optical stimulation of a specimen without introducing unwanted time-domain modulation.

In accordance with one embodiment, a method for optically stimulating a specimen is disclosed. The method comprises (i) using a spatial light modulator (SLM) to produce an SLM image containing a plurality of regions having different grayscales from each other, each region being produced by turning on a predetermined percentage of pixels within the region while keeping a remainder of applicable pixels within the region turned off, the predetermined percentage of pixels corresponding to a percentage of grayscale of the region, and (ii) optically projecting the SLM image onto a specimen via an optical system having a sufficient de-magnification such that the specimen treats individual pixels in the SLM image indiscriminately.

Additional features and advantages of embodiments will be set forth in the description, which follows, and in part will be apparent from the description. The objectives and other advantages of the invention will be realized and attained by the structure particularly pointed out in the example embodiments in the written description and claims hereof as well as the appended drawings. It is to be understood that both the foregoing general description and the following detailed description are illustrative and explanatory and are intended to provide further explanation of the invention as claimed.

### BRIEF DESCRIPTION OF THE DRAWINGS

Various embodiments of the present invention are illustrated by way of example and are not limited to the following figures:

FIG. 1A illustrates an optical illumination system in which an illustrative embodiment can be carried out.

FIG. 1B illustrates an example of an SLM image having regions with different grayscales.

FIG. 2 illustrates an exploded view of the SLM image of FIG. 1B.

FIG. 3 is a flow chart showing an exemplary set of functions carried out using the optical illumination system of FIG. 1A.

FIG. 4 illustrates a processing system in accordance with one embodiment.

### DETAILED DESCRIPTION

Various embodiments and aspects of the invention will be described with reference to details discussed below, and the accompanying drawings will illustrate the various embodiments. The following description and drawings are illustrative of the invention and are not to be construed as limiting the invention.

In this regard, different arrangements described herein are provided by way of example only, and other arrangements and elements can be added or used instead and some elements may be omitted altogether. Also, those skilled in the art will appreciate that many of the elements described herein are functional entities that may be implemented as discrete components or in conjunction with other components, in any suitable combination and location, and various functions could be carried out by software, firmware and/or hardware.

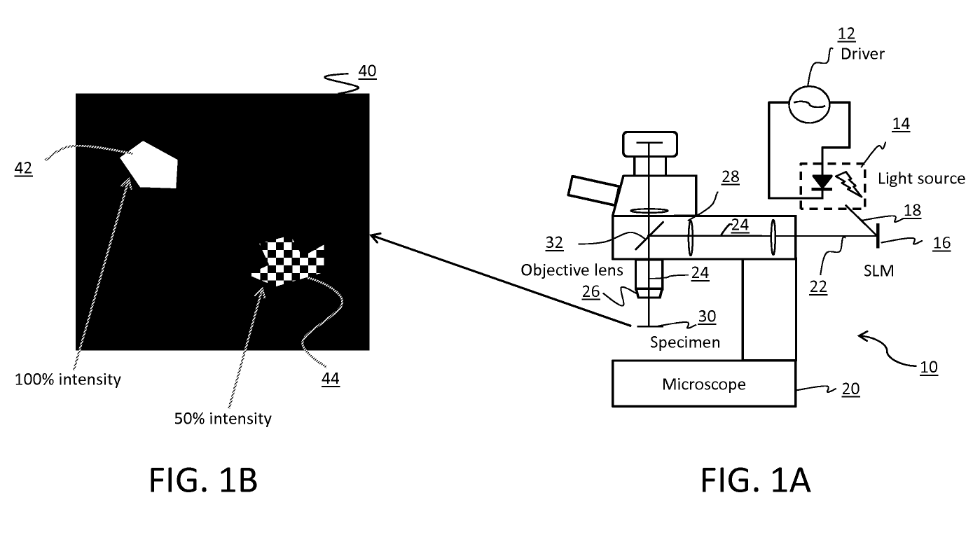

FIG. 1A depicts an optical illumination system 10 in which an illustrative embodiment of the present invention could be carried out.

As shown in FIG. 1A, the optical illumination system 10 comprises a driver 12 coupled to a light source 14 configured to illuminate a binary SLM 16 (hereafter “SLM 16”) with light. Although FIG. 1 shows a direct light path 18 between the light source 14 and the SLM 16, any suitable optical component(s) may be used between the light source 14 and the SLM 16 in the light path 18 to direct light output by the light source 14 onto the SLM 16.

The optical illumination system 10 further comprises a microscope system 20 (also referred to as “Microscope” in FIG. 1A) that receives an image output by the SLM 16 via an optical path 22. Although not explicitly shown in FIG. 1A, it should be understood the optical path 22 between an output of the SLM 16 and an input into the microscope system 20 may include additional optical component(s) (e.g., multiple lense(s)) in order to efficiently couple an SLM image light into the microscope system 20. Further, the SLM 16 may be positioned appropriately with respect to the input to the microscope system 20 to direct light into the input to the microscope system 20.

As further shown in FIG. 1A, the SLM image light input to the microscope system 20 passes through an internal optical path 24 within the microscope system 20 before being projected via an objective lens 26 onto a specimen 30. In the illustrative embodiment, the SLM 16 and the specimen 30 are in conjugate planes. As illustrated, the internal optical path 24 of the microscope system 20 may include a number of lenses 28 and beam splitter(s) 32 that can manipulate the SLM image light as needed to project it onto the specimen 30. Preferably, the specimen 30 is a biological specimen, such as neuron(s) or cell(s), that can be optically stimulated through suitable light illumination.

Note, however, that the microscope system 20 and its internal arrangement is provided for illustrative purposes only, and it may be possible to use other optical system(s) instead. For example, it may be possible to use another optical system arranged to function as a microscope and configured in accordance with principles of the present disclosure.

In general, the driver 12 is provided to control or modulate the light source 14 by turning the light source 14 on or off the light source 12 may be any suitable one or more sources of light, such as a light-emitting diode (LED) (as shown in FIG. 1) or a solid-state laser device. In the illustrative embodiment, the light source 12 may generate white light. Alternatively, the light source 12 may be a light source generating light of a given color (or wavelength) (e.g., blue or red light) or a combination of colors (or wavelengths).

In the illustrative embodiment, light output by the light source 14 is directed onto the SLM 16 that, in turn, can modulate this light in accordance with an image pattern loaded into the SLM 16. Generally, the image pattern loaded into the SLM 16 represents an image data according to which the SLM 16 will modulate light input to the SLM 16 to produce a desired output image. Preferably, the SLM 16 is a digital micromirror device (“DMD”). However, in other embodiments, the SLM 16 may be, for instance, in the form of a liquid crystal display (“LCD”) device including an imaging portion made up of a pixel array.

As those skilled in the art will recognize, a typical DMD will include a large number of microscopic mirrors that each represent an individual pixel and can be controlled to be either in an “on” state or an “off” state in accordance with binary data. The mirrors/pixels are arranged in a two-dimensional array of rows and columns, and the DMD can modulate incoming light in accordance with an image data to output a desired image. Further, the dimensions of the pixel array will depend on the resolution of the DMD (e.g., 1024 rows by 768 columns).

Although not shown, one skilled in the art will recognize that the SLM 16, such as a DMD, will be configured with suitable hardware, processing unit(s), memory, software/logic modules, input lines, buses, and the like, to process an image pattern input into the SLM 16 and load it into appropriate portions of the pixel array of the SLM 16. In this regard, data represented by the image pattern can be loaded to the pixel array in any suitable fashion, such as on a row-by-row basis.

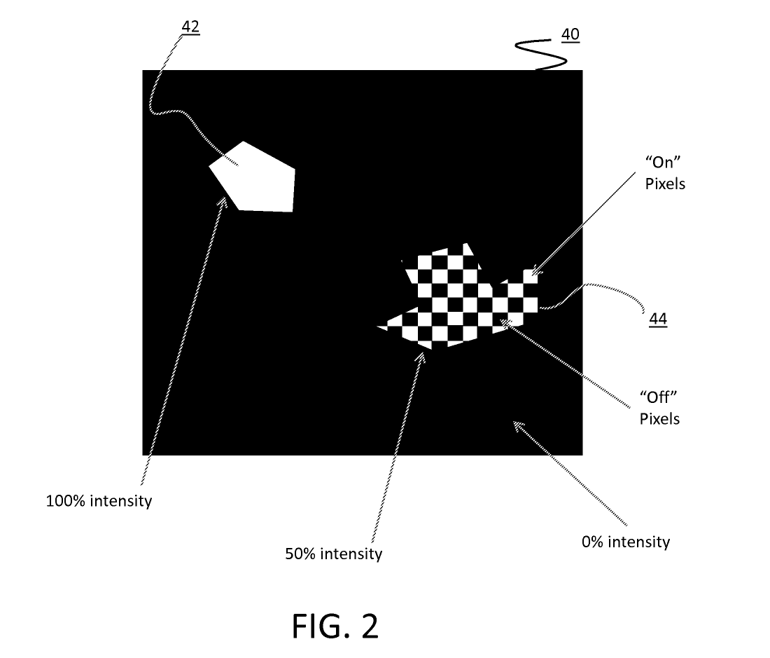

As a general matter, in accordance with the illustrative embodiment, the SLM 16 produces an output image, or as referred herein, an SLM image. The SLM image is projected onto a specimen receiving optical stimulation (e.g., the specimen 30) via the microscope system 20, where such image contains regions of different optical intensities, or grayscales. More specifically, the SLM image 40 is projected onto the specimen 30 so that selected areas of the specimen 30 are illuminated with a desired optical intensity (or “intensity,” for short). FIG. 1B shows an example of the SLM image 40 projected onto the specimen 30. FIG. 2 depicts an expanded view of the SLM image 40 in FIG. 1B with some additional details.

As shown in FIGS. 1B and 2, the SLM image 40 includes a region 42 with 100% intensity and a region 44 with 50% intensity to illuminate corresponding areas of the specimen 30. The remaining portions of the SLM image 40 may be viewed as region(s) with 0% intensity, as shown in FIG. 2.

Further, in accordance with the illustrative embodiment, grayscale illumination within an illumination area can be achieved by turning on only a part of pixels on the SLM 16 that cover, or are within, that area. An average intensity is proportional to a number of pixels that are turned on. For example, if half (or 50%) of the pixels are turned on within one illumination area, then an average intensity within that area would be 50% (see, for example, the region 44), thereby generating a 50% grayscale illumination pattern. If all (or 100%) pixels are turned on within another illumination area (see, for example, the region 42), then full (or 100%) intensity is achieved, thereby generating a 100% grayscale illumination pattern.

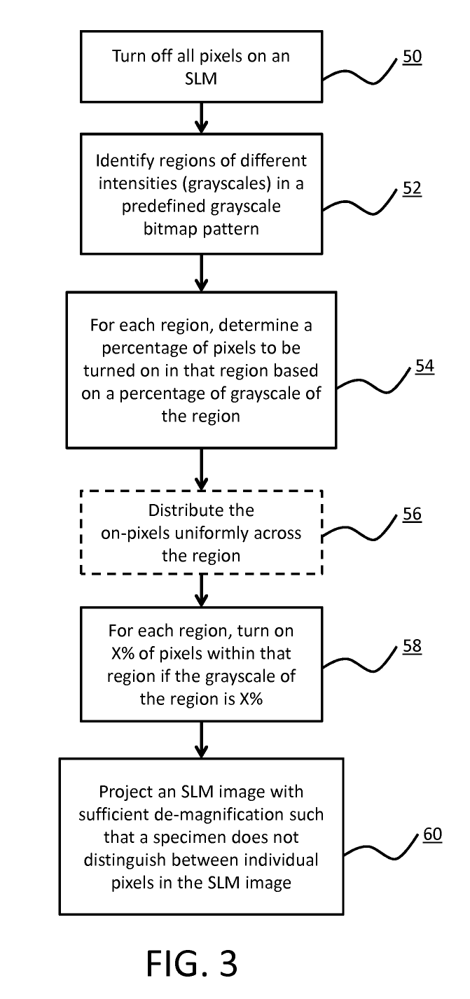

Various features of the present invention will be now explained in greater detail with reference to a flow chart of FIG. 3 illustrating an exemplary set of functions that could be carried out using the optical illumination system 10.

As shown in FIG. 3, initially, at step 50, all of pixels on the SLM 16 are turned off. As such, the entire SLM output image area appears dark, since no light is emitted from the pixels. At this step, the light source 14 may be turned off by the driver 12 so no light is directed onto the SLM 16. Alternatively, the light source 14 may be turned on, and pixel elements on the SLM 16 (e.g., mirrors on the DMD) may be controlled accordingly so that no light is output by those pixel elements.

At step 52, a plurality of regions having different intensities, or grayscales, from each other are identified in a predefined grayscale bitmap pattern. As known in the digital imaging art, a bitmap generally refers to an image file format in which an a digital image is made up of array or grid of pixels. A bitmap pattern typically defines a spatially mapped array of pixels, where each pixel may be assigned a value indicating pixel intensity (or grayscale).

Note that grayscale, in a scientific contents, generally means intensities between a “full-on” (e.g., 100% intensity (grayscale)) and a “full-off” (e.g., 0% intensity (grayscale)). Thus, the terms “intensity” (or “optical intensity) and grayscale may be used here interchangeably.

At step 52, to identify the plurality of regions having different grayscales, one may provide a computer program in the form of a computer-readable program code configured to go through the predefined grayscale bitmap pattern pixel by pixel and read pixel values associated with grayscale. For example, if the grayscale bitmap pattern contains three areas with different grayscale levels, then the program code will be configured to identify these three areas on the basis of their pixel values.

Then, at step 54, for each region identified in the predefined grayscale bitmap pattern, a percentage of pixels in that region that are to be turned on is determined based on a percentage of grayscale of that region. Namely, a percentage of pixels in a given region that are to be turned on corresponds to a grayscale of the given region. As such, in the illustrative embodiment, if a grayscale of a given region is X %, then X % of pixels in that region are to be turned on, while a remainder of the pixels (if any) in that region are to be turned of.

At step 56, the on-pixels may be distributed uniformly across the region so that when the specimen 30 is illuminated, an intensity within an illumination area corresponding to that region is perceived by the specimen 30 as being uniform. In this regard, given a desired grayscale level, there are a number of ways to assign which pixels are on and which are off. One may consider methods developed for digital halftoning used in printing applications. As an example, one method to uniformly distribute the on-pixels across the region is to randomly select X % of pixels in the region.

Based on the steps 52-56, a binary image pattern suitable to be loaded into the SLM 16 may be generated and loaded into the SLM 16. The image pattern specifies which pixels on the SLM 16 are to be turned on within each region identified as having a given intensity (grayscale). As such, the SLM 16 can modulate light output from the light source 14 in accordance with the image pattern loaded into the SLM 16.

Namely, in accordance with the image pattern loaded into the SLM 16, at step 58, for each region identified in step 52, X % of pixels within that region are turned on if the grayscale of that region is X %. At this step, the light source 14 is on and illuminating the SLM 16.

To illustrate, as shown in FIG. 2 for instance, in the SLM image 40 projected onto the specimen 30, all pixels within the region 42 are turned on the SLM 16 to generate 100% intensity. On the other hand, only 50% of pixels within the region 44 are turned on the SLM 16 to generate 50% intensity. Since, at step 50, all of the pixels on the SLM 16 are turned off, remaining portions of the SLM image 40 remain dark.

Note that a calculation of the X % of pixels within the region may yield a fraction of a pixel. In such case, a number of pixels to be turned on may be rounded up or down accordingly to the nearest whole number of pixels.

One of the features of the present embodiment is that optical magnification, or more specifically, optical de-magnification, of an optical system via which an SLM image is projected onto a specimen (e.g., a neuron) is arranged such that the specimen treats individual pixels in the SLM image indiscriminately. With such de-magnification, the specimen would typically be covered by many pixels and would not distinguish, or discriminate, between individual pixels in the projected SLM image. An amount of de-magnification of the optical system (e.g., the microscope system 20) must be sufficient so that an image of an individual SLM pixel is small enough such that the specimen does not distinguish between individual pixels in the SLM image and thus does not respond differently to the individual pixels.

If the optical de-magnification is configured this way, then an element receiving an optical stimulation only responds to a spatial average optical intensity. Hence, the element would only perceive an average optical intensity of a given region in the SLM image (e.g., 50% average intensity of all pixels within the entire region 44 in the SLM image 40) rather than an optical intensity of individual pixels within that region.

Hence, step 60 involves projecting an SLM image onto a specimen with sufficient de-magnification such that the specimen does not distinguish between individual pixels in the SLM image. In this regard, an individual pixel in the SLM image projected onto the specimen (e.g., the specimen 30) would have to be de-magnified sufficiently so that a projected pixel size is smaller than a spatial resolution of a specimen response.

To illustrate, one way to determine a sufficient de-magnification amount, such as in the optical illumination system 10, would be to project two adjacent pixels of the same size on the SLM 16 onto the specimen 30 via the microscope system 20. The adjacent pixels could be a left pixel and a right pixel. Each of those pixels would be illuminated with the same light and turned on in an alternating manner, i.e., when the left pixel is on, the right pixel is off, and so on. If the optical system 20 does not sufficiently de-magnify a projected pixel in size, then the specimen 30 would be able to detect when the left pixel emits light and when the right pixel emits light, and respond to illumination by each individual pixel. The de-magnification of the optical system 20 can be gradually adjusted until the specimen 30 can no longer discriminate between the two pixels and does not respond to each individual pixel.

However, it should be understood that there may be other ways of determining sufficient optical de-magnification. As another example, if one knows characteristics of a specimen under study (e.g., its size), one could determine a sufficient optical de-magnification amount based on the characteristics of the specimen itself. Further, as a general matter, a de-magnification of a given optical system (e.g., the microscope system 20) would be related to its magnification. For example, a microscope with 100× magnification would generally have a de-magnification of 100× (i.e., it would be able to de-magnify an element (e.g., a pixel image) to 1/100 of its original size).

As noted above, in traditional PWM techniques, an optical intensity of a pixel may be varied by turning the pixel on and off for certain time periods, leading to undesirable effects.

In contrast, with the benefit of the illustrative embodiment, in order to control an optical intensity within a given region of the SLM image 40, a certain number of pixels within that region are turned on while the rest of the pixels in that region may be turned off. The number of the on-pixels corresponds to a grayscale level/percentage of that region. For example, if a region A is made up X pixels and a grayscale percentage defined for the region A is 60%, then 60% of the X pixels would be on, while the remaining 40% of the pixels within the region A would be turned off. This way, collectively, a specimen, such as a neuron, would perceive the region A as having about 60% intensity relative to 100% intensity if all of the X pixels within the region A were turned on.

Advantageously, using the scheme in accordance with the illustrative embodiment, the pixels are “static”, and thus do not introduce unwanted time-domain modulation as the PWM scheme does. In other words, the pixels are either continuously on or off, such as during the entire period of optical stimulation. This is unlike PWM in which case pixels within a grayscale region are modulated by periodically turning them on and off, and thus have to be turned off at some point during the stimulation.

Note that FIG. 3 is provided for illustrative purposes only, and variations are possible. As one example, the steps 52-56 may be carried out prior to the step 50 in which all pixels on an SLM are turned of.

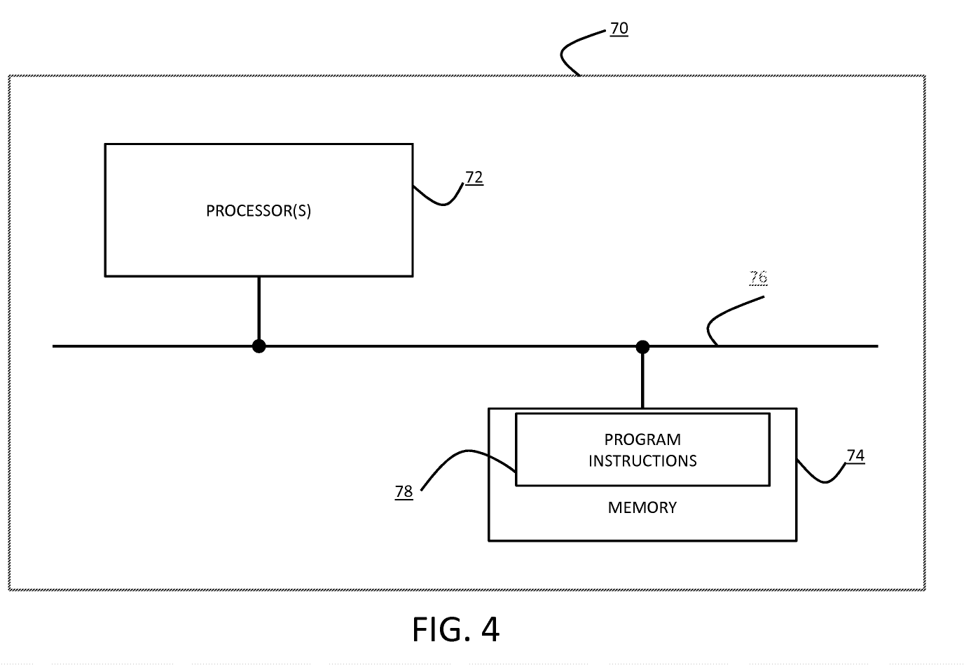

Further, various functions described herein, such as in FIG. 3 above, could be carried out by a processing system 70, as shown in FIG. 4. The system 70 includes at least one processor 72 and memory 74, coupled together via a bus 76. The processing system 70 may be separate from the SLM 16 or may be integrated fully or partially with the SLM 16. For example, the processing system 70 may be incorporated in a separate controller controlling the element(s) of the optical illumination system 10 (e.g., the SLM 16, the driver 12, etc.) or its components may be distributed accordingly across the element(s) of the optical illumination system 10. Various examples are possible.

In one embodiment, the processor(s) 72 may be dedicated processor(s) or general purpose processor(s) configured to execute computer-readable program code. The memory 74 may be volatile or non-volatile non-transitory computer-readable medium or media, now known or later developed. The memory 74 may hold program logic comprising program instructions 78 (e.g., machine language instructions) executable by the processor(s) 72 to carry out various functions described herein. Additionally, the memory 74 may store any other data, such as data used by the processor(s) 72 in the execution of the program instructions 78. However, any additional data may be also be held in other data storage location(s) separate from the memory 74.

Further, although not shown in FIG. 4, the processing system 70 may include a number of interfaces, such as user interface(s), communication interface(s) (e.g., an interface for communicating data to/from the memory 74, etc.), and/or the like. Also, other elements (e.g., modules, input lines, buses, etc.) may be included as well.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B are satisfied by any one of the following: A is true (or present) and B is false (or not present), A is false (or not present) and B is true (or present), and both A and B are true (or present).

The terms “a” or “an,” as used herein, are defined as one or more than one. The term “plurality,” as used herein, is defined as two or more than two. The term “another,” as used herein, is defined as at least a second or more.

The invention can be implemented in numerous ways, including as a process, an apparatus, and a system. In this specification, these implementations, or any other form that the invention may take, may be referred to as techniques. In general, the order of the connections of disclosed apparatus may be altered within the scope of the invention.

The present invention has been described in particular detail with respect to some possible embodiments. Those skilled in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component. An ordinary artisan should require no additional explanation in developing the methods and systems described herein but may nevertheless find some possibly helpful guidance in the preparation of these methods and systems by examining standard reference works in the relevant art.

These and other changes can be made to the invention in light of the above detailed description. In general, in the following claims, the terms used should not be construed to limit the invention to the specific embodiments disclosed in the specification and the claims, but should be construed to include all methods and systems that operate under the claims set forth herein below. Accordingly, the invention is not limited by the invention, but instead its scope is to be determined entirely by the following claims.

1. A method for optically stimulating a specimen, comprising:
using a spatial light modulator (SLM) to produce an SLM image containing a plurality of regions having different grayscales from each other, each region being produced by turning on a predetermined percentage of pixels within the region while keeping a remainder of applicable pixels within the region turned off, the predetermined percentage of pixels corresponding to a percentage of grayscale of the region; and
optically projecting the SLM image onto a specimen via an optical system having a sufficient de-magnification such that the specimen treats individual pixels in the SLM image indiscriminately.

2. The method of claim 1, further comprising:
identifying, by at least one processor, the plurality of regions in a predefined grayscale bitmap pattern.

3. The method of claim 1, further comprising:
turning off all pixels on the SLM prior to turning the predetermined percentage of pixels on.

4. The method of claim 1, wherein the optical system includes a microscope.

5. The method of claim 1, wherein the predetermined percentage of pixels within the region is substantially equal to the percentage of grayscale of the region.

6. The method of claim 1, wherein a size of a pixel in the SLM image projected onto the specimen is small enough such that the specimen does not distinguish between individual pixels in the SLM image.

7. The method of claim 1, wherein the specimen is a biological specimen.

8. The method of claim 7, wherein the biological specimen includes a neuron.

9. The method of claim 1, further comprising illuminating the SLM with light.

10. The method of claim 1, wherein the predetermined percentage of pixels within the region are turned on continuously during the entire period of optical stimulation.

11. The method of claim 1, wherein the plurality of regions are projected onto the specimen to illuminate corresponding portions of the specimen.

12. The method of claim 1, further comprising:
determining an amount of de-magnification that is sufficient.

13. The method of claim 1, wherein the remainder of applicable pixels is zero.

14. A system for optically stimulating a specimen, comprising:
a spatial light modulator (SLM) configured to produce an SLM image containing a plurality of regions having different grayscales from each other, each region being produced by turning on a predetermined percentage of pixels within the region while keeping a remainder of applicable pixels within the region turned off, the predetermined percentage of pixels corresponding to a percentage of grayscale of the region; and
an optical system coupled to the SLM and configured to project the SLM image onto a specimen, the optical system having a sufficient de-magnification such that the specimen treats individual pixels in the SLM image indiscriminately.

15. The system of claim 14, wherein the optical system includes a microscope.

16. The system of claim 14, wherein the predetermined percentage of pixels within the region is substantially equal to the percentage of grayscale of the region.

17. The system of claim 14, wherein the specimen is a biological specimen.

18. The system of claim 17, wherein the biological specimen includes a neuron.

19. The system of claim 14, wherein the optical system is configured to de-magnify pixels in the SLM image sufficiently so that a size of a pixel in the SLM image projected onto the specimen is small enough such that the specimen does not distinguish between individual pixels in the SLM image.

20. The system of claim 14, further comprising:
a light source configured to illuminate the SLM with light.

21. The system of claim 20, wherein the SLM modulates light output by the light source in accordance with an image pattern loaded into the SLM to produce the SLM image.

22. The system of claim 14, wherein the remainder of applicable pixels is zero.
